(19) United States
(12) Patent Application Publication
(10) Pub. No.: US 2014/0288881 A1
(43) Pub. Date: Sep. 25, 2014

(54) HOIST PERFORMANCE DIAGNOSTIC, IMPLEMENTATION AND SUSTAINING SERVICES

(71) Applicant: ABB Technology AG, Zurich (CH)

(72) Inventors: KEVIN DALE STARR, Lancaster, OH (US); BENGT T. HENDLUND, Skelleftea (SE)

(73) Assignee: ABB Technology AG, Zurich (CH)

(21) Appl. No.: 13/847,247

(22) Filed: Mar. 19, 2013

(51) Int. Cl. G01M 99/00; B66F 19/00

(52) U.S. Cl. CPC G01M 99/00; B66F 19/00
USPC 702/183; 702/182

(57) ABSTRACT

Aspects assure the performance of a hoist system. Some aspects model different shape segments to different portions of braking pressure levels acquired over time during an emergency braking event. A linear shape is modeled to braking pressure values decreasing over a first time interval from initiation of the emergency braking event. A constant shape is modeled to generally constant acquired braking pressure values of a next, second time interval, another linear shape modeled to braking pressure values decreasing over a next, third time interval, and another constant shape is modeled to the braking pressure values acquired over a fourth interval from a time at which the speed value drops to zero, until an exponential shape is modeled to braking pressure values of a subsequent fifth interval. A pressure value defined by the constant shape modeled over the fourth interval determines a permissible braking pressure value for the emergency braking event.

### FIELD OF THE INVENTION

Embodiments of the present invention relate to automated systems that diagnose problems, implement solutions, and sustain performance metrics relevant to hoist systems and infrastructure.

### BACKGROUND

Hoists are mechanical systems and infrastructure that lift and/or lower work pieces by overcoming loads imparted by gravity or other forces. Hoists generally bear the imparted load and move the work pieces by wrapping cabling such as cable, rope or chain about motive pulleys, drums and lift-wheels. Hoists may incorporate a large variety of individual electronic and mechanical brake, bearing and hydraulic components and systems in order to accomplish their motive objectives. In order to ensure safe and satisfactory performance the individual components and systems of the hoist should be monitored in order to assure adequate or specified performances, and to recognize and diagnose problems that may arise in the monitored performances and in the overall hoist system. Hoists designed for large loads and large-scale implementations generally require more robust and complicated components and systems, and this creates commensurate increases in management and service overhead and complexities in maintaining and operating a deployed hoist.

### BRIEF SUMMARY

In one aspect of the present invention, a method assures the performance of a hoist system. Data is acquired associated with an emergency braking event executed in a hoist system that includes a braking system, a skip, and lift roping. The hoist system conveys the skip upward and downward via motive operation of the lift roping, and the acquired data includes braking pressure levels and speeds of the skip observed over time during the emergency braking event. Different shape segments are modeling to different portions of the braking pressure levels observed over different time intervals as a function of the acquired speed data during each of the intervals. Thus, a linear shape model is modeled to the acquired braking pressure values that are progressively decreasing over a first of the time intervals that runs from an initiation time of the emergency braking event to an onset of a second of the time intervals that includes generally constant braking pressure values of the acquired braking pressure values. A constant shape model is modeled to the generally constant acquired braking pressure values of the second time interval. A linear shape model is modeled to the acquired braking pressure values that are progressively decreasing over a third of the time intervals that runs from an end time of the second time interval to a time at which the speed value drops to zero. A constant shape model is modeled to the braking pressure values acquired over a fourth of the intervals that is defined from the time at which the speed value drops to zero to a beginning in time of a progressive exponential reduction in the acquired braking pressure values. An exponential shape model is modeled to the braking pressure values acquired over a fifth of the intervals occurring after an end of the fourth interval. Accordingly, a pressure value defined by the modeled constant shape model of the braking pressure values acquired over the fourth interval is determined to be a permissible braking pressure value for the hoist system for the emergency braking event.

In another aspect, a system has a processing unit, computer readable memory and a tangible computer-readable storage medium with program instructions, wherein the processing unit, when executing the stored program instructions, acquires data is associated with an emergency braking event executed in a hoist system that includes a braking system, a skip, and lift roping. The hoist system conveys the skip upward and downward via motive operation of the lift roping, and the acquired data includes braking pressure levels and speeds of the skip observed over time during the emergency braking event. The processing unit models different shape segments to different portions of the braking pressure levels observed over different time intervals as a function of the acquired speed data during each of the intervals. Thus, a linear shape model is modeled to the acquired braking pressure values that are progressively decreasing over a first of the time intervals that runs from an initiation time of the emergency braking event to an onset of a second of the time intervals that includes generally constant braking pressure values of the acquired braking pressure values. A constant shape model is modeled to the generally constant acquired braking pressure values of the second time interval. A linear shape model is modeled to the acquired braking pressure values that are progressively decreasing over a third of the time intervals that runs from an end time of the second time interval to a time at which the speed value drops to zero. A constant shape model is modeled to the braking pressure values acquired over a fourth of the intervals that is defined from the time at which the speed value drops to zero to a beginning in time of a progressive exponential reduction in the acquired braking pressure values. An exponential shape model is modeled to the braking pressure values acquired over a fifth of the intervals occurring after an end of the fourth interval. Accordingly, the processing unit determines a permissible braking pressure value for the hoist system for the emergency braking event as a pressure value defined by the modeled constant shape model of the braking pressure values acquired over the fourth interval.

In another aspect, a computer program product for assuring the performance of a hoist system has a tangible computer-readable storage medium with computer readable program code embodied therewith, the computer readable program code comprising instructions that, when executed by a computer processing unit, cause the computer processing unit to acquire data is associated with an emergency braking event executed in a hoist system that includes a braking system, a skip, and lift roping. The hoist system conveys the skip upward and downward via motive operation of the lift roping, and the acquired data includes braking pressure levels and speeds of the skip observed over time during the emergency braking event. The processing unit is further caused by the program code instructions to model different shape segments to different portions of the braking pressure levels observed over different time intervals as a function of the acquired speed data during each of the intervals. Thus, a linear shape model is modeled to the acquired braking pressure values that are progressively decreasing over a first of the time intervals that runs from an initiation time of the emergency braking event to an onset of a second of the time intervals that includes generally constant braking pressure values of the acquired braking pressure values. A constant shape model is modeled to the generally constant acquired braking pressure values of the second time interval. A linear shape model is modeled to the acquired braking pressure values that are progressively decreasing over a third of the time intervals that runs from an end time of the second time interval to a time at which the speed value drops to zero. A constant shape model is modeled to the braking pressure values acquired over a fourth of the intervals that is defined from the time at which the speed value drops to zero to a beginning in time of a progressive exponential reduction in the acquired braking pressure values. An exponential shape model is modeled to the braking pressure values acquired over a fifth of the intervals occurring after an end of the fourth interval. Accordingly, the processing unit is further caused by the program code instructions to determine a permissible braking pressure value for the hoist system for the emergency braking event as a pressure value defined by the modeled constant shape model of the braking pressure values acquired over the fourth interval.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a graphic illustration of a skip hoist system.

FIG. 2 is a flow chart illustration of a system or method for assuring performance of a hoist system according to the present invention.

FIG. 2 is a graphic illustration of a portion of an interactive graphical user interface dashboard according to the present invention.

FIG. 3 is a graphic illustration of a graphic illustration of the relationship of detected brake pressure and speed of movement of the hoist work piece over time.

FIG. 4 is a graphic illustration of a shape identification algorithm model according to the present invention fit to the pressure curve of FIG. 3.

FIG. 5 is a block diagram illustration of a computerized implementation of an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

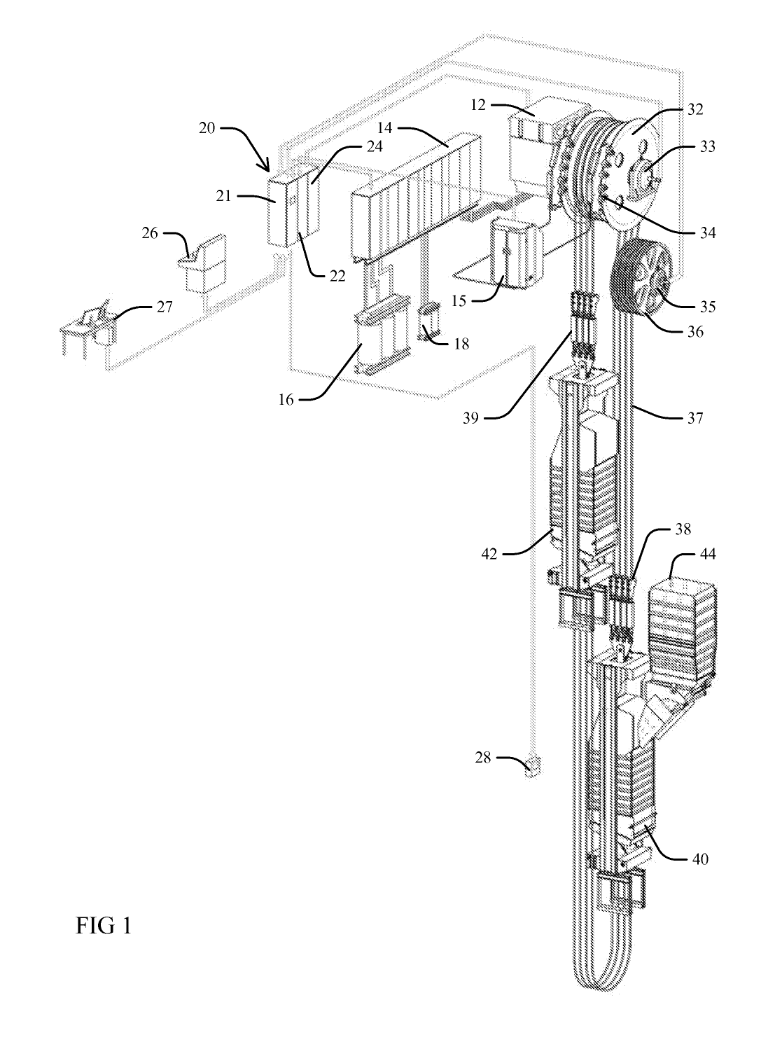

FIG. 1 illustrates one example of a skip hoist system. An automated hoist control and monitoring system 20 comprising hoist control system 21, hoist monitoring system 22 and brake control system 24 components is in control communication with a hoist operator desk 26 located near the system 20, and also with a hoist operator central control room 27 and a local control panel 28.

The skip hoist has a hoist motor 12, a hoist drive inverter 14, the inverter's main transformer 16 and an exciter transformer 18. A friction-type pulley 32 is engaged by a hoist control pulse encoder 33 and a plurality of brake caliper units 34 that are controlled by the brake control system 24 via a brake hydraulic power and control unit 15.

A rope slippage pulse encoder 35 engages sheaves 36 for each of a plurality of lift ropes 37 that are deployed over the friction-type pulley 32 and attached at either end to each of a pair of skips 40 and 42 via hydraulic rope attachments 38 and 39, respectively. The ropes 37 may be ropes, chains, cables, etc., and it will be understood that the use of the terms “lift roping” and “lift ropes” in this specification, including in the claims, is not limited to woven strands of hemp or synthetic material conventionally designated as rope, but comprehends metal cables and cabling, chain and other elements that are flexible and able to wrap about a pulley or drum 32 and thereby responsively lift or lower a skip 40/42 or other work piece in response to gravity and to the operation of said pulley/drum 32, etc.

The skips 40 and 42 are container used to move work piece material up or down, such as mined ore or other material, grain, scrap metal, and various other bulk items that may be held by container. In the present example the skip 40 is shown in communication with a measuring and ore loading flask 44 that is used to deposit mining material into the skip 40 for conveyance upward and unloading. For purposes of illustration hoist systems are discussed herein with respect to skips, but one skilled in the art will appreciate that a wide variety of hoist work pieces may be conveyed upwards and downwards in moving loads, including elevator cars that carry personnel, bins, scoops, etc. Thus, the term “skip” as used in the specification and the claims will be understood to be a generic term signifying a wide variety of hoist work pieces may be conveyed upwards and downwards in moving loads.

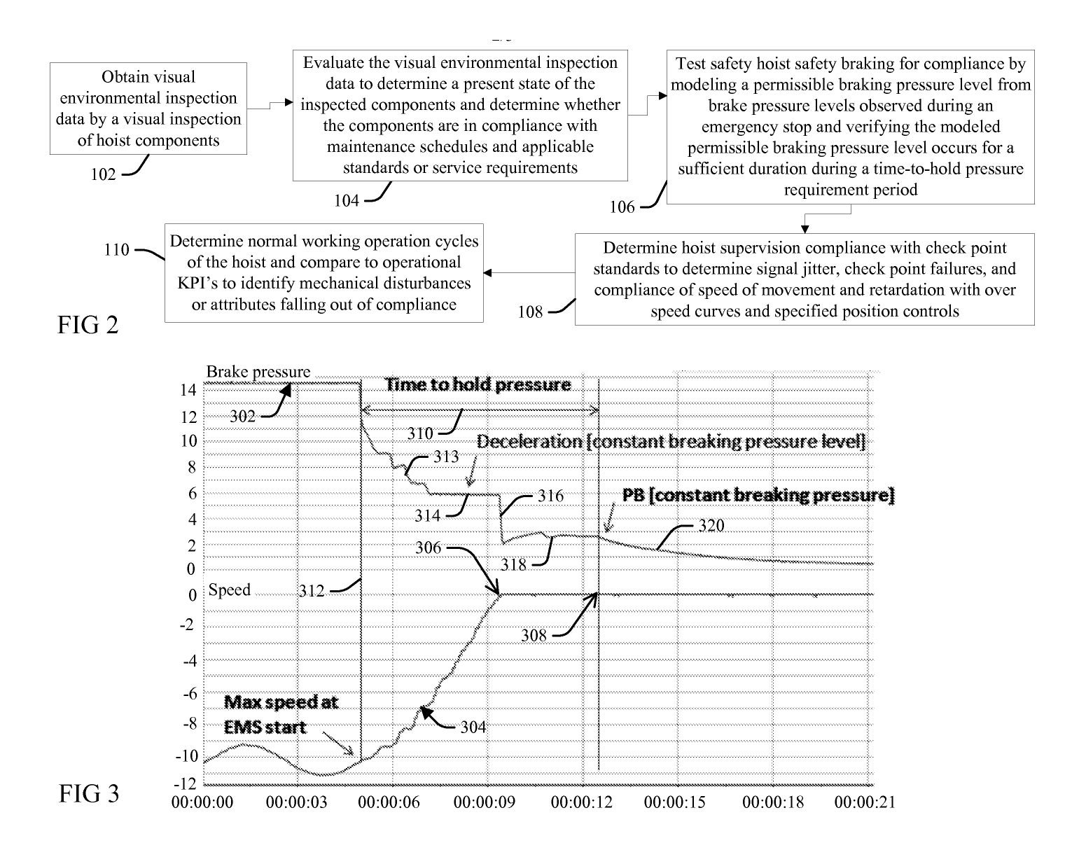

FIG. 2 illustrates a system or method for assuring performance of a hoist system, including the hoist system shown in FIG. 1. At 102 visual environmental inspection data is collected or acquired or otherwise obtained by a visual inspection of a plurality of different components of a hoist including pulleys, drums and lift-wheels; brakes; motors and their immediately surrounding areas; cabling and/or chains and/or ropes used for lifting and lowering skips or other work piece loads; hydraulic and/or pneumatic hoses and valves; and the hoist components installation. The visual environmental inspection data may be acquired on a regular (periodic basis), and by direct visual review and inspection by a service technician, manager, maintenance worker or other person, or it may be acquired remotely via still or video camera or visual data scanners. At 104 the visual environmental inspection data is evaluated to determine a present state of the inspected components and determine whether the components are in compliance with maintenance schedules and applicable standards or service requirements.

A wide variety of visual inspection data may be acquired at 104 and tested against key performance indicators and other standards at 106. For example, the circuit boards for programmable electrical devices and systems should appear in good working order, free of cracked or damaged or worn out elements, including resistors. Motors and surrounding areas should be clean and free of coal dust or other explosion or combustion hazards, with data collection at 104 including checking stators and collectors to determine if there has been any sparks, couplings for tachogenerators and pulse generators, and shaft rotations to make sure they are not wobbly. Spill cups are checked for quantities of fluid. Brakes should be clean, and brake discs should have smooth, undamaged or scratched surfaces, and caliper pads or shoes should not be worn beyond replacement tolerances. Hydraulic and/or pneumatic hoses and valves should be clean, without evidence of leaking fluids visible on the components or pooled into puddles in the area, etc. Still other visual inspection data collection and analysis procedures useful to the proactive maintenance of the mechanical health of hoist components and their operations will be apparent to one skilled in the art, and the examples provided herein are only illustrative and not exhaustive.

At 106 safety hoist safety braking components and systems are tested for compliance with safety brake Key Performance Indicators (KPI's) that are specified for the hoist by modeling a permissible braking pressure level from brake pressure levels observed during an emergency stop, and verifying that the modeled, permissible braking pressure level occurs for a sufficient duration during a time-to-hold pressure requirement period. More particularly, the testing at 106 analyzes pluralities of signals generated by the hoist systems in response to one or more emergency stops, including determining true or false states or values of an in-motion signal that indicates whether a load containing element of the hoist is in motion and being hoisted up or down (true), or it is instead stopped (false); an emergency stop signal initiating (true) an emergency stop, that is otherwise false during normal operations; a speed signal conveying a value of the rate of motion of the hoist load containing element up or down; and a brake pressure signal indicative of the engagement of brakes that stop hoist pulleys or drums from moving, and thereby the skip or other work piece. The speed signal and brake pressure signal values are used to model and compare the permissible braking pressure level to a time-to-hold pressure requirement period specification, as is discussed more fully below.

At 108 compliance with hoist supervision KPI's is determined. Hoist position check points are compared to KPI standards to determine signal jitter or check point failure. Speed of movement is evaluated, for example determining wherein the hoist control system properly controls speed of retardation, if an over speed curve is sufficient, and if the position control is sufficient. Maintenance procedures are reviewed and compared to appropriate key performance indicators. Illustrative but not exhaustive examples of hoist supervision criteria considered at 108 include:

1. How often is backup made on software for the control system on the complete hoist?

2. How often are batteries changed on the brake system?

3. How often are the hoist test functions being controlled?

4. How often is the motors coal level controlled?

5. How often are the spill cups on the hydraulic units controlled?

6. How often is the brake disc controlled?

7. How often are the bearings controlled?

8. Has there been done any analysis on the motor current? If yes, what was the result?

9. Has there been done any vibration measuring? If yes, what was the result?

10. How often is the filter's switched for the lubrication on the bearings?

11. How often is the filter's switched on the brake system?

12. How often is there a minor fault on the hoist? (Minor fault means a fault that is easy to reset.)

13. How often is there a major fault on the hoist? (Major fault means a fault that causes a longer stop.)

14. What are causing the minor faults? (Brake system, Control system or Drive system?)

14a. What are the causes on the brake system when minor faults occur? (Specific valve fault? Air gap? Oil temperature? Retardation fault?)

14b. What are the causes on the control system when minor faults occur? (Checkpoint fault? Synchronization fault? PG fault Communication fault? Position fault? Over/Under wind? Tail rope switch?)

14c. What are the causes on the drive system when minor faults occur? (Over current? Torque fault? Over current field? Communication fault? Over temperature? Over temperature on motor? Earth fault? Earth fault on motor?)

15. What are causing the major faults? (Brake system, Control system or Drive system?)

15a. What are the causes on the brake system when major faults occur? (Broken brake disc? Oil leakage? Broken valves? Broken brake unit? Dirt in oil? Broken BCC card?)

15b. What are the causes on the control system when major faults occur? (Checkpoint fault? Synchronization fault? PG fault? Communication fault? Position fault? Over/Under wind? Tail rope switch?)

15c. What are the causes on the drive system when major faults occur? (Over current? Torque fault? Over current field? Communication fault? Over temperature? Over temperature on motor? Earth fault? Earth fault on motor?)

16. Are there any spare parts kept on hand that are needed for the brake system? (Backup brake card? Valves? Complete brake unit? Air gap sensors?)

17. Are there any spare parts kept on hand that are needed for the control system? (I/O Units? Sensors? Relays?)

18. Are there any spare parts kept on hand that are needed for the drive system? (I/O card? Communication equipment? Thyristors?)

19. How much is the hoist production each hour?

20. How many hours a day is the hoist running?

21. How many days a week is the hoist running?

22. How often is one day reparation work scheduled on the hoist?

23. How often is the setting on the hydraulic station controlled?

24. Has there been done any analysis on the Pulsetransmitter or Pulsgivare (PG) signals? If yes, what was the result?

It is noted that actual hoist speeds can be determined from the PG signal that are indicative of mechanical disturbances. Still other supervisory criteria appropriate for application at 108 will be apparent to one skilled in the art.

At 110 the normal working operation cycles of the hoist are determined and compared to operation KPI's to discern mechanical disturbances and identify attributes that may be falling out of compliance. Operation cycle attributes include cycle times through an iteration of multiple tasks and individual dumping station times and filling station times and balance tests, in one aspect in order to determine at 110 if time benchmarks for individual tasks or for elapsed times cycling through multiple tasks. Normal stops are assessed at 110 for compliance with retardation rate, valve sequence, proportional valve sequences, and time-to-hold pressure KPI's that are specified for normal operation stops, in some aspects by modeling brake pressure levels as discussed below and comparing the modeled levels to normal stopping specifications that differ from the specifications applied to the emergency stops assessed at 106.

In aspects of the present invention an emergency stop event start condition is indicated at 106 as a point in time when brake pressure drops below 80%, and wherein the stop condition is met when the brake pressure is below a specified zero threshold value and an in-motion signal (or “InMotion”) is false for a minimum time period (for example at least four seconds). In some aspects minimums and maximums are determined for the brake pressure and in-motion and other signals to determine binary, true-false levels, wherein no transition between states is determined to occur if Max−Min<0.5. For stop events, if the emergency stop signal Max−Min>0.5, then the stop event is classified as an emergency stop. An emergency stop must also meet a retardation rate KPI that specifies maximum and minimum allowable rates for stopping: not too fast, which would result in a hard, jarring stop, and not too long or slow.

The relative positions of non-proportional and proportional hydraulic or pneumatic system valves are specified for an emergency stop at 106, which may be distinguished from non-emergency stop conditions applied at 110. More particularly, the relative positions of certain identified valves must comply with a specified emergency stop valve triggering pattern and timing sequence at 106. In one example using minimum (“min”) and maximum (“max”) values for binary true/false indicators, an ON/OFF valve transition is determined when a valve crosses down by “10 Hysteresis 2 T_ON 0.1,” and an OFF/ON transition is determined when a valve crosses up “8 Hysteresis 2 T_ON 0.1”. Sequential patterns of transitions of specified valves may thus be observed in an emergency stop and compared to specified patterns, for example verifying that certain (first, second and third) valves have only one transition, and that certain other (fourth and fifth) valves have an “either or” transition within specified time frames. Pattern transition times are observed and used to verify that that the time between the transition of the first and second valves is within a first threshold time (for example, 50 milliseconds), and that this transition also occurs within a second threshold time period of a transition of the third valve (for example, 200 milliseconds). Said determined pattern is also required to show at 106 that a transition of the fourth or fifth valve is triggered after the speed reaches zero speed.

A time to hold braking pressure is specified and applied in the emergency braking system assessment at 106. The objective of this test is to make sure that a braking system pressure accumulator holds pressure for a specified safe amount of time. Aspects auto-detect the pressure over time to determine a constant, stable Permissible Braking (PB) pressure level occurring over a specified or determined stable time period, reporting a problem if one-half the value of the maximum speed is less than the time the accumulator holds the PB pressure level pressure, as further reduced by a specified preventive factor value that allows for an extra safety margin. This test may be represented by [(Time from Maximum Speed at beginning of emergency stop to stopped)/2<((Time to hold pressure)−2)].

FIG. 3 is a graphic illustration of the relationship of detected brake pressure and speed of movement over time of the hoist work piece, such as the skip 40/42, or an elevator car, bin, scoop, etc. During motion of the skip the brakes calipers 34 are held back from a forceful engagement of the hoist pulley 32 in response to pressure exerted on the calipers 34 by hydraulic or pneumatic lines, and the value of this pressure over time is illustrated by the brake pressure plot 302. The speed of motion of the hoist skip over the same time frame is illustrated by the speed of motion pressure plot 304. The brake pressure is held steady at a level over 14 megapascals (MPa) during the normal, maximum speed (in meters-per-second) of the hoist skip movement until the initiation of an emergency stop at about the five second point, wherein the pressure drops over time down. When the pressure drops to two MPa the brakes bring the hoist to a complete stop (zero speed) at just over nine seconds (00:00:09). Though the pressure rises slightly subsequent to this point in time, to as much as three MPa before falling again to two MPa and then tailing off further after about twelve second (00:00:12), the brakes remain engaged and the hoist skip stopped at a point 308 about three seconds after the stopping point 306. Thus, if the additional preventive factor time value is three seconds or less, this emergency stop passes a time-to-hold pressure requirement specified at 106 and indicated by the time span period 310 starting at the initiation of the emergency stop at 312.

It is noted that the brake pressure curve 302 shows multiple, different periods of stable pressure levels that have long duration times during the constant deceleration period from the EMS (emergency stop) start point 312 to the end of the “time to hold pressure” period at 308: Upon initiation of the EMS at 312 a first segment 313 of the brake pressure level drops from the steady high pressure level disengaging the brakes over time and then plateaus as a second segment 314 which describes a first constant pressure level period. During the first and second segments the drop in brake pressure causes the brakes to engage the hoist and cause a deceleration of the speed of the hoist progressively over time. The first constant pressure level of the second segment 314 transitions to a third segment 316 that shows a rapid, linear drop in pressure 316 drop to a fourth segment 318 of pressure levels wherein the hoist is brought to a complete stop at 306 and held in the stopped position throughout the remainder of the time-to-hold pressure period 310. During the remainder fifth segment 320 of the pressure plot the hoist is held in the stopped position.

Aspects of the present invention use the generally constant brake pressure values of the fourth segment 318 to define the permissible braking pressure (PB) level that is used to determine whether the emergency stop complies with the time-to-hold pressure requirements of the emergency brake specification at 106. In order to distinguish the fourth segment, generally constant pressure level values from other periods of stable pressure levels during the “time to hold pressure,” such as the second segment 314, in order to thereby identify the PB level, aspects use a shape identification modeling processes, systems and algorithms at 106.

In one example the shape is defined as comprising an unknown segment [T0], a first constant segment [T1], a linear segment [T2], a second constant segment [T3] and an exponential [T4], wherein model variables are the duration times of each sections T0, T1, T2 and T3. T4 is by default a total duration, [Sum (T0:T3)]. Error is optimized between the model and the actual data, and the second constant segment T2 is selected as the PB pressure value. To avoid a local minimum the model is optimized multiple times (for example, ten) with different starting parameters for T0. The best resulting model is selected, and the PB value extracted out of it as the value of the second constant segment. It also noted that the actual time T1+T2+T3 might be less precise as an estimator of the PB transition point, and therefore some aspects obtain the actual PB transition time by testing the condition when the pressure crosses down below (0.98*PB) for at least two seconds.

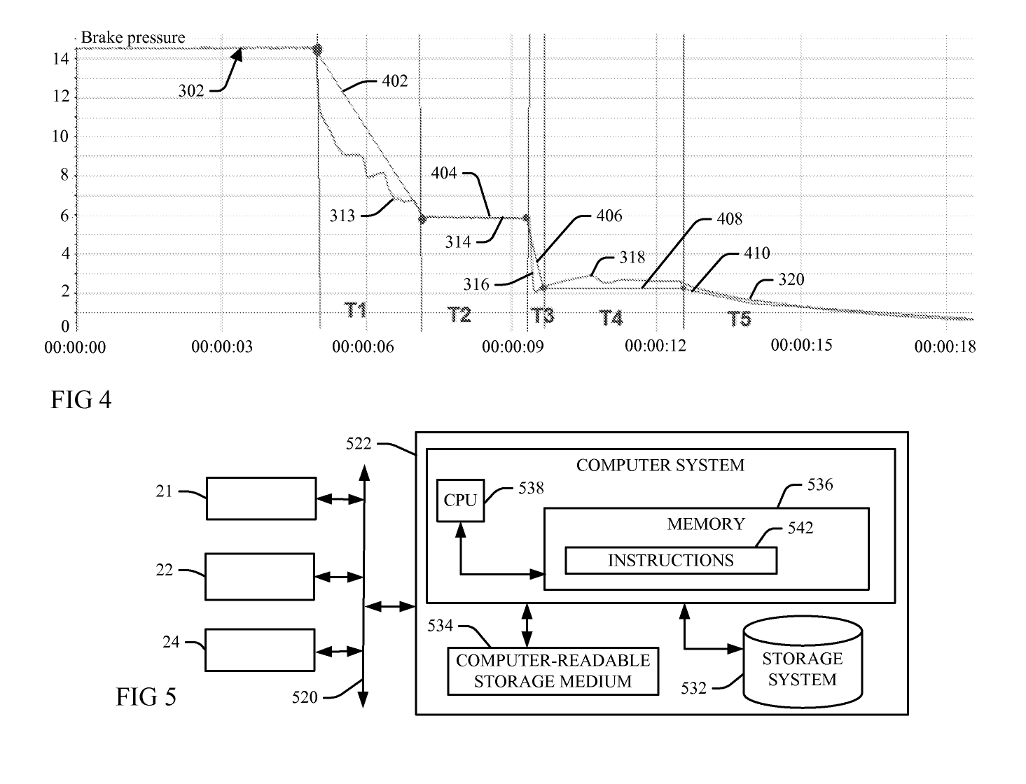

FIG. 4 is a graphic illustration of a shape identification algorithm model fit to the pressure curve 302 of FIG. 3. The algorithm determines position point segments modeled to portions of the pressure plot as a function of determining shape type and interval duration. Thus, P₁ 402 is a linear decrease segment modeled over the time period T₁ to the pressure plot segment 313. P₂ 404 is a constant pressure level segment modeled over the next time period T₂ to the pressure plot segment 314. P₃ 406 is another linear decrease segment modeled over the next time period T₃ to the pressure plot segment 316. P₄ 408 is a second constant pressure level segment modeled over the next time period T₄ to the pressure plot segment 318. Lastly, P₅ 410 is an exponential decrease segment modeled over the final time period T₅ to the pressure plot segment 320.

The respective shape types of the modeled segments 402, 404, 406, 408 and 410 are determined by best fits over their respective ranges of previous pressure value points (Pᵢ₋₁ to Pᵢ), wherein the interval duration (Tᵢ) is the time between (Pᵢ₋₁) and (Pᵢ). (Tₙ) is not used, as by default it represents the total duration, for example (Sum (T₁: Tn₋₁)). At (T₀) the model value is input value zero, and all other points (Pᵢ) are modeled based on the fit shape. Thus, if the shape is constant the model function for all points between (Tᵢ₋₁) and (Tᵢ) is the model value at (Tᵢ₋₁). If the shape is a linear decrease or increase then the model function for all points between (Tᵢ₋₁) and (Tᵢ) is the linear function [a*x+b], wherein parameters (a) and (b) are computed based on the model value at (Tᵢ₋₁) and the input value at (Tᵢ). If the shape is unknown, then the model function for all points between (Tᵢ₋₁) and (Tᵢ) is the input value; this returns a perfect fit, note however that in the bias function each point of type unknown shape will have a small penalty. If the shape is the exponential increase or decrease, then the model function for all points between (Tᵢ₋₁) and (Tᵢ) is the exponential function [e^{(a+bx)}], wherein parameters (a) and (b) are computed based on the model value at (Tᵢ₋₁) and the input value at (Tᵢ).

Aspects of the present invention also incorporate a bias function at 110 that enables guiding a solution in a feasible and desirable solution domain. For example, every point in an unknown model shape may be assigned a penalty that is adjusted via a bias function so that the penalty is at least higher than a signal noise level. In some aspects there is a high penalty if (Tᵢ) is smaller than five samples, and the model is forced to fit each shape to some extent. Generally there is a high penalty if [SUM (T₁:Tₙ₋₁)] is greater than a total number of samples.

Aspects of the present invention also incorporate an optimization function at 110 that provides for an initial model to optimize and a best model for reference purposes as a function of a number (E) of acceptable errors and a number (N) of iterations. In some examples the initial model is optimized every iteration using a Nelder-Mead method optimizer class. A Nelder-Mead method is a nonlinear optimization technique for twice differentiable problems, sometimes referred to as a downhill simplex method or amoeba method. If model error determined for a new model iteration is lower than that of the best known model, we the new model iteration is the new best model. Thus, the Nelder-Mead loop is repeated as for (N) iterations, and interrupted if the error is lower than the acceptable error (E). It is also noted that the algorithm may be iterated externally, as well with different initial model values to avoid local optimums.

Aspects of the present invention generally perform emergency stop testing in the middle of the shaft containing the skips, and control the temperature on the brake disc so that it doesn't rises over a maximum threshold, for example 45 degrees centigrade. If the hoist has two hydraulic brake stations then the emergency stop test is generally performed with both, otherwise they should be measured separately. If the hoist has a double skip, then two emergency stops tests should be made, one at full speed with no load, and one at full speed with a full load in the upward skip.

If the hoist has single skip/cage with a counterweight, then three emergency stops tests should be made: one at full speed, no load in the skip/cage and skip/cage downwards; one at full speed with a full load in skip/cage and skip/cage upwards; and one at allowed speed, no load in skip/cage and skip/cage upwards. In this scenario the hoist will run with a negative load, which means that the heavy side runs downwards. Previous stop test records should be reviewed first to ensure that the hoist can successfully execute this test.

If the hoist is a drum hoist then three emergency stops tests should be made: one at full speed, no load in skip/cage and skip/cage downwards; one at full speed, no load in skip/cage and skip/cage upwards; and one at full speed, full load in skip/cage and skip/cage upwards. In this scenario an overly hard retardation may cause slack rope, and thus previous stop test records should be reviewed first to ensure that the hoist can successfully execute this test.

Aspects of the present invention also determine the relation between the proportional signal [control signal] and pressure [out signal] in assessing braking performance at 106 and 110. In one example, in a first step data is isolated where the pressure is not affected by other non-proportional valve actions: for example, with reference to the first-through-fifth valves discussed above, two seconds after the first, second and third valves that have only one transition, and until fourth valve “either-or” transition. A first order model plus time delay is used to analyze the relation between the proportional-valve and pressure for the previously selected time period, and proportional-valve behavior problems reported is the best model found with a model error above a threshold, for example 0.4.

In some aspects determining and comparing the normal working operation cycles of the hoist to operation KPI's at 110 discerns mechanical disturbances and identifies attributes that may be falling out of compliance by analyzing the in-motion signal, the emergency stop signal, the speed signal and the brake pressure signal, and position and load signals. The in-motion signal and position signals are analyzed to identify cycles, and the emergency stop signal is analyzed to identify and report cycles that had emergency stops. In some aspects measuring the hoist cycle time is at a resolution of at least 20 ms, over a length of time of at least 20 min, in one aspect to make sure that all the signals have correct scaling and that they are working properly. If there are two hydraulic stations (or pneumatic) for the brake system then both should be run when performing hoist cycle measuring.

When the measuring pulse and tacho encoder performance, pulse and/or tacho encoder signal and position channels are generally used at a resolution of at least 100 μs, capturing the hoist when it runs at full speed over two measurements, one up and one down.

In some aspects normal operation cycles are detected or otherwise determined at 110 by determining the maximum and minimum (min, max) of the in-motion signal, wherein if the difference between the in-motion max and min values is less than a normalized 0.8 then it is assumed that there was no transition. It is noted that the in-motion signal value may be a binary or digital zero or one, true or false value; or an analog signal varying from zero to ten volts; and still other values and ranges may be practiced. All possible “half-cycle” event transitions (“HalfCycle”) are then determined and identified by the following:

Start Condition: InMotion crosses up (Max+Min)/2 for at least 4 seconds;

Stop Condition: InMotion crosses below (Max+Min)/2 for at least 4 seconds.

Minimum and maximum positions “PosMin” and “PosMax”, respectively, are then determined for each of the respective determined half-cycles according to the following:

```
To get a full cycle as movement from a PosMin to a PosMax and back to
the PosMin:
If Not cycleStartFound Then
  If Position(HalfCycle.StartTime−1sec,HalfCycle.StartTime+1sec).Min <
  PosMin +
  0.01 * (PosMax − PosMin) Then
```

cycleStartFound = True
cycleStart = e.StartTime
CycleStops = 0

```
  End If
Else
  If Position(.StopTime−1sec,HalfCycle.StopTime+1sec).Min <
  PosMin + 0.01 *
  (PosMax − PosMin) Then
  cycleStartFound = False
  cycleEnd = e.StopTime
  Define a new HoistCycle(cycleStart, cycleEnd)
  Else
  ‘an unexpended stop occurred during the cycle
  CycleStops += 1
  End If
```

Unknown stops are found in some aspects at 110 based on additional in-motion transitions during a hoist cycle. For example, normally an in-motion signal should have four transitions per cycle, representing one stop to load, and another stop to dump, and the movement between these events and back to the start of the next cycle. However, if the hoist stops at a half-way point for five minutes then the data will show two additional transitions. Hoist cycle detection according to the present invention therefore uses position as well as in-motion signal data to accurately determine and mark hoist cycle events.

The following describes a filling station event detection at 110 in aspects of the present invention, and it is noted that a dumping station event analysis is very similar. Initially the longest event where the hoist's position was above (PosMax−0.01*(PosMax−PosMin)) is determined. A “StartCondition” is determined for a Position that crosses above the (PosMax−0.01*(PosMax−PosMin)) for at least 2 seconds, and a “StopCondition” as a Position that crosses down (PosMax−0.01*(PosMax−PosMin)) for at least 2 seconds. Within the determined longest event the precision of the filling station identification location is improved by setting the following conditions on the in-motion signal: for the StartCondition: in-motion crosses down ((InMotionMax+InMotionMin)/2) for at least two seconds; and for the StopCondition: in-motion crosses up ((InMotionMax+InMotionMin)/2) for at least two seconds. The resulting event is identified as a filling station event.

Aspects of the present invention also identify creep speed, full speed and creep-to-stop attributes of the hoist at 110. The determination is similar for upward and downward movement of the skip, and accordingly the following example of a downward movement determination also teaches an upward motion determination to one skilled in the art. A creep speed event is detected by determining that a transition speed crosses up a transition speed threshold for at least a threshold speed transition period, in one example 1.1 meters-per-second (m/s) for at least two seconds. It is noted that in this example the 1.1 m/s is a fixed value and not currently exposed as a parameter, although the transition speed threshold value may also be auto detected using the shape identification modeling processes described above with respect to FIGS. 3 and 4.

The creep speed-to-stop event is detected based on determining that the condition speed crossed down the transition speed threshold value for at least a threshold speed transition period, for example by 1.1 m/s for at least two seconds. The acceleration-to-full speed, full speed and deceleration-to-creep speed are detected using the shape identification modeling processes described above with respect to FIGS. 3 and 4, as configured for a first segment linear, a constant segment and a second linear segment. It is noted that the shape analyzed might have multiple disturbances, for example long creep speed periods or almost no creep speed periods, an overshoot after acceleration to full speed before getting to a stable full speed state, or two acceleration rates during the acceleration to full speed event or deceleration to creep speed event. Creep speed levels may also be fixed so that cycles are evenly compared or auto-detected, providing a stable auto detection mechanism wherein an associated algorithmic process requires less analysis parameters on the users side and may auto adjust to on-site system configuration changes.

Hoist performance services according to the aspects described above provide for a three-step diagnose, implement and sustain methodology that audits and analyzes control systems so high-impact opportunities can be identified for improvement. The diagnostic phase includes benchmarking existing performance to have a basis for evaluating and identifying improvement opportunities. A resulting implementation plan identifies corrective activities for performance improvement and associated financial benefits. Once the improvement plan has been implemented, sustaining services delivered on-site or remotely provide the means to maintain and continue process improvements.

In contrast, conventional hoist performance analysis is very manual and provides limited amounts of data to engineers and maintenance technicians determine problems and resolutions. However, manual efforts are not generally effective in processing the large amount of data associated with the operation of complex hoist systems. Automated hardware tools according to the present invention utilize software instructions to simplify complex operating data analysis and identify anomalies that cause poor performance.

Thus, the aspects described above may generate a hoist performance fingerprint that audits and analyzes the hoist system to deliver high-impact resolutions for anomalies and issues that cause poor performance. The fingerprint uses analyzer components to ensure hoist system performance is not affected while the audit collects system topology and configuration information. Outputs of the on-site focused process audit include performance benchmark, financial impact, and an implementation plan of recommended improvements.

The hoist performance fingerprint is a foundation for achieving improved hoist system performance levels. To achieve total hoist system optimization, an implementation plan may be developed by service and end-user (customer) representatives through a collaborative review of the fingerprint findings and recommendations. By ensuring changes and updates are managed, the implementation plan helps to maximize hoist system performance and extend its life.

Recommended corrective actions may be output by a hoist fingerprint. An implementation phase may be described as hands-on corrections implemented by a customer or third party provider. Recommendations vary by site and help resolve performance issues and outline steps required to maximize performance. Several classes of recommendations may flow from a fingerprint implementation. Recommendations with respect to control of the brake capacity may verify that the supervision is reliable and overall health of the brake system. Recommendations with respect to visual inspection of brakes and motors may increase safety, and improve scheduled proactive maintenance. Recommendations with respect to analyzing hoist cycles may optimize the production, safety and the wear of mechanical equipment. Recommendations with respect to brake tests at emergency stop may verify good retardation at emergency stop and functionality of valves. Recommendations with respect to control of proactive maintenance may propose recommendations for improvement.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium excludes transitory, propagation or carrier wave signals or subject matter and includes an electronic, magnetic, optical, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that does not propagate but can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Referring now to FIG. 5, an exemplary computerized implementation of an embodiment of the present invention includes a computer system or other programmable device 522 in communication with the hoist control system 21, hoist monitoring system 22 and brake control system 24 components of FIG. 1. Instructions 542 reside within computer readable code in a computer readable memory 536, or in a computer readable storage system 532, or other tangible computer readable storage medium 534 that is accessed through a computer network infrastructure 520 by a processing unit (CPU) 538. Thus, the instructions, when implemented by the processing unit (CPU) 538, cause the processing unit (CPU) 538 to assure performance of a hoist system as described above with respect to FIGS. 1-4.

Embodiments of the present invention may also perform process steps of the invention on a subscription, advertising, and/or fee basis. That is, a service provider could offer to integrate computer-readable program code into the computer system 522 to enable the computer system 522 to assure performance of a hoist system as described above with respect to FIGS. 1-4. The service provider can create, maintain, and support, etc., a computer infrastructure such as the computer system 522, network environment 520, or parts thereof, that perform the process steps of the invention for one or more customers. In return, the service provider can receive payment from the customer(s) under a subscription and/or fee agreement. Services may comprise one or more of: (1) installing program code on a computing device, such as the computer device 522, from a tangible computer-readable medium device 534 or 532; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the Figures, may be distinguished or otherwise identified from others by unique adjectives (e.g., a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated herein.

What is claimed is:

1. A method for assuring the performance of a hoist system, the method comprising:
acquiring data associated with an emergency braking event executed in a hoist system that comprises a braking system, a skip, and lift roping, wherein the hoist system conveys the skip upward and downward via motive operation of the lift roping, and wherein the acquired data comprises braking pressure levels and speeds of the skip observed over time during the emergency braking event;
modeling a plurality of different shape segments to different portions of the braking pressure levels over different time intervals as a function of the acquired speed data during each of the intervals, by:
modeling a linear shape model to the acquired braking pressure values that are progressively decreasing over a first of the time intervals that runs from an initiation time of the emergency braking event to an onset of a second of the time intervals that comprises generally constant braking pressure values of the acquired braking pressure values;
modeling a constant shape model to the generally constant acquired braking pressure values of the second time interval;
modeling the linear shape model to the acquired braking pressure values that are progressively decreasing over a third of the time intervals that runs from an end time of the second time interval to a time at which the speed value drops to zero;
modeling a constant shape model to the braking pressure values acquired over a fourth of the time intervals that is defined from the time at which the speed value drops to zero to a beginning in time of a progressive exponential reduction in the acquired braking pressure values; and
modeling an exponential shape model to the braking pressure values acquired over a fifth of the time intervals occurring after an end of the fourth time interval; and
determining that a pressure value defined by the modeled constant shape model of the braking pressure values acquired over the fourth time interval is a permissible braking pressure value for the hoist system for the emergency braking event.

2. The method of claim 1, further comprising:
determining that the performance of the hoist system meets a key performance indicator in response to determining that the fourth time interval is at least as long as a specified safe amount of time for a pressure accumulator of the braking system to hold pressure for the emergency braking event, and occurs during a specified time-to-hold pressure period elapsed since the initiation time of the emergency braking event.

3. The method of claim 2, further comprising:
identifying the acquired speed value at the initiation time of the emergency braking event as a maximum speed of the skip;
determining a decelerating time period from the maximum speed initiation time to the time at which the speed value drops to zero; and
determining that the performance of the hoist system fails to meet a key performance indicator in response to a time value of one-half of a length of the decelerating time period being less than the time-to-hold pressure period reduced by the specified safe amount of time.

4. The method of claim 3, further comprising:
acquiring visual environmental inspection data by a visual inspection of the braking system, the work piece load, and the lift roping;
evaluating the acquired visual environmental inspection to identify a present state of each of the inspected braking system, the work piece load, and the lift roping; and
determining that the performance of the hoist system fails to meet a key performance indicator in response to the evaluating determining that:
the lift roping is frayed beyond an acceptable level;
the lift roping is corroded beyond an acceptable level; or
a component of the braking system or and a surrounding area of the braking system component has visual evidence of leaking fluids that are prohibited.

5. The method of claim 3, further comprising:
determining maximum and minimum values of an in-motion signal;
determining a transition between start and stop conditions of a normal operation cycle of the hoist system in response to determining that a difference between the in-motion maximum and minimum values is equal to or greater than a normalized 0.8;
determining a half-cycle event start condition in response to the value of the in-motion signal crossing above one-half of a total of the in-motion maximum value and the in-motion minimum value for a specified transition time period; and
determining a half-cycle event stop condition in response to the value of the in-motion signal crossing below one-half of the total of the in-motion maximum value and the in-motion minimum value for the specified transition time period.

6. The method of claim 5, wherein the specified safe amount of time is two seconds, and the specified transition time period is four seconds.

7. The method of claim 1, further comprising:
integrating computer-readable program code into a computer system comprising a processing unit, a computer readable memory and a computer readable tangible storage medium, wherein the computer readable program code is embodied on the computer readable tangible storage medium and comprises instructions that, when executed by the processing unit via the computer readable memory, cause the processing unit to perform the steps of:
acquiring the data associated with the emergency braking event executed in the hoist system, modeling the different shape segments to the different portions of the braking pressure levels over the different time intervals by modeling the linear shape model to the acquired braking pressure values that are progressively decreasing over the first of the time intervals, modeling the constant shape model to the generally constant acquired braking pressure values of the second time interval, modeling the linear shape model to the acquired braking pressure values that are progressively decreasing over the third time interval, modeling the constant shape model to the braking pressure values acquired over the fourth time intervals and modeling the exponential shape model to the braking pressure values acquired over the fifth time interval; and
determining that the pressure value defined by the modeled constant shape model of the braking pressure values acquired over the fourth time interval is the permissible braking pressure value for the hoist system for the emergency braking event.

8. A system, comprising:
a processing unit in communication with a computer readable memory and a tangible computer-readable storage medium;
wherein the processing unit, when executing program instructions stored on the tangible computer-readable storage medium via the computer readable memory:
acquires data associated with an emergency braking event executed in a hoist system that comprises a braking system, a skip and lift roping, wherein the hoist system conveys the skip upward and downward via motive operation of the lift roping, and wherein the acquired data comprises braking pressure levels and speeds of the skip observed over time during the emergency braking event;
models a plurality of different shape segments to different portions of the braking pressure levels over different time intervals as a function of the acquired speed data during each of the intervals, by:
modeling a linear shape model to the acquired braking pressure values that are progressively decreasing over a first of the time intervals that runs from an initiation time of the emergency braking event to an onset of a second of the time intervals that comprises generally constant braking pressure values of the acquired braking pressure values;
modeling a constant shape model to the generally constant acquired braking pressure values of the second time interval;
modeling the linear shape model to the acquired braking pressure values that are progressively decreasing over a third of the time intervals that runs from an end time of the second time interval to a time at which the speed value drops to zero;
modeling a constant shape model to the braking pressure values acquired over a fourth of the time intervals that is defined from the time at which the speed value drops to zero to a beginning in time of a progressive exponential reduction in the acquired braking pressure values; and
modeling an exponential shape model to the braking pressure values acquired over a fifth of the time intervals occurring after an end of the fourth time interval; and
determines that a pressure value defined by the modeled constant shape model of the braking pressure values acquired over the fourth time interval is a permissible braking pressure value for the hoist system for the emergency braking event.

9. The system of claim 8, wherein the processing unit, when executing the program instructions stored on the computer-readable storage medium via the computer readable memory, further:
determines that the performance of the hoist system meets a key performance indicator in response to determining that the fourth time interval is at least as long as a specified safe amount of time for a pressure accumulator of the braking system to hold pressure for the emergency braking event, and occurs during a specified time-to-hold pressure period elapsed since the initiation time of the emergency braking event.

10. The system of claim 9, wherein the processing unit, when executing the program instructions stored on the computer-readable storage medium via the computer readable memory, further:
identifies the acquired speed value at the initiation time of the emergency braking event as a maximum speed of the skip;
determines a decelerating time period from the maximum speed initiation time to the time at which the speed value drops to zero; and
determines that the performance of the hoist system fails to meet a key performance indicator in response to a time value of one-half of a length of the decelerating time period being less than the time-to-hold pressure period reduced by the specified safe amount of time.

11. The system of claim 10, wherein the processing unit, when executing the program instructions stored on the computer-readable storage medium via the computer readable memory, further:
acquires visual environmental inspection data by a visual inspection of the braking system, the work piece load, and the lift roping;
evaluates the acquired visual environmental inspection to identify a present state of each of the inspected braking system, the work piece load, and the lift roping; and
determines that the performance of the hoist system fails to meet a key performance indicator in response to the evaluating determining that:
the lift roping is frayed beyond an acceptable level;
the lift roping is corroded beyond an acceptable level; or
a component of the braking system or and a surrounding area of the braking system component has visual evidence of leaking fluids that are prohibited.

12. The system of claim 10, wherein the processing unit, when executing the program instructions stored on the computer-readable storage medium via the computer readable memory, further:
determines maximum and minimum values of an in-motion signal;
determines a transition between start and stop conditions of a normal operation cycle of the hoist system in response to determining that a difference between the in-motion maximum and minimum values is equal to or greater than a normalized 0.8;
determines a half-cycle event start condition in response to the value of the in-motion signal crossing above one-half of a total of the in-motion maximum value and the in-motion minimum value for a specified transition time period; and
determines a half-cycle event stop condition in response to the value of the in-motion signal crossing below one-half of the total of the in-motion maximum value and the in-motion minimum value for the specified transition time period.

13. The system of claim 12, wherein the specified safe amount of time is two seconds, and the specified transition time period is four seconds.

14. A computer program product for assuring the performance of a hoist system, the computer program product comprising:
a computer readable tangible storage medium having computer readable program code embodied therewith, the computer readable program code comprising instructions that, when executed by a computer processing unit, cause the computer processing unit to:
acquire data associated with an emergency braking event executed in a hoist system that comprises a braking system, a skip and lift roping, wherein the hoist system conveys the skip upward and downward via motive operation of the lift roping, and wherein the acquired data comprises braking pressure levels and speeds of the skip observed over time during the emergency braking event;
model a plurality of different shape segments to different portions of the braking pressure levels over different time intervals as a function of the acquired speed data during each of the intervals, by:
modeling a linear shape model to the acquired braking pressure values that are progressively decreasing over a first of the time intervals that runs from an initiation time of the emergency braking event to an onset of a second of the time intervals that comprises generally constant braking pressure values of the acquired braking pressure values;
modeling a constant shape model to the generally constant acquired braking pressure values of the second time interval;
modeling the linear shape model to the acquired braking pressure values that are progressively decreasing over a third of the time intervals that runs from an end time of the second time interval to a time at which the speed value drops to zero;
modeling a constant shape model to the braking pressure values acquired over a fourth of the time intervals that is defined from the time at which the speed value drops to zero to a beginning in time of a progressive exponential reduction in the acquired braking pressure values; and
modeling an exponential shape model to the braking pressure values acquired over a fifth of the time intervals occurring after an end of the fourth time interval; and
determine that a pressure value defined by the modeled constant shape model of the braking pressure values acquired over the fourth time interval is a permissible braking pressure value for the hoist system for the emergency braking event.

15. The computer program product of claim 14, wherein the computer readable program code instructions, when executed by the computer processing unit, further cause the computer processing unit to:
determine that the performance of the hoist system meets a key performance indicator in response to determining that the fourth time interval is at least as long as a specified safe amount of time for a pressure accumulator of the braking system to hold pressure for the emergency braking event, and occurs during a specified time-to-hold pressure period elapsed since the initiation time of the emergency braking event.

16. The computer program product of claim 15, wherein the computer readable program code instructions, when executed by the computer processing unit, further cause the computer processing unit to:
identify the acquired speed value at the initiation time of the emergency braking event as a maximum speed of the skip;
determine a decelerating time period from the maximum speed initiation time to the time at which the speed value drops to zero; and
determine that the performance of the hoist system fails to meet a key performance indicator in response to a time value of one-half of a length of the decelerating time period being less than the time-to-hold pressure period reduced by the specified safe amount of time.

17. The computer program product of claim 16, wherein the computer readable program code instructions, when executed by the computer processing unit, further cause the computer processing unit to:
acquire visual environmental inspection data by a visual inspection of the braking system, the work piece load, and the lift roping;
evaluate the acquired visual environmental inspection to identify a present state of each of the inspected braking system, the work piece load, and the lift roping; and
determine that the performance of the hoist system fails to meet a key performance indicator in response to the evaluating determining that:
the lift roping is frayed beyond an acceptable level;
the lift roping is corroded beyond an acceptable level; or
a component of the braking system or and a surrounding area of the braking system component has visual evidence of leaking fluids that are prohibited.

18. The computer program product of claim 16, wherein the computer readable program code instructions, when executed by the computer processing unit, further cause the computer processing unit to:
determine maximum and minimum values of an in-motion signal;
determine a transition between start and stop conditions of a normal operation cycle of the hoist system in response to determining that a difference between the in-motion maximum and minimum values is equal to or greater than a normalized 0.8;
determine a half-cycle event start condition in response to the value of the in-motion signal crossing above one-half of a total of the in-motion maximum value and the in-motion minimum value for a specified transition time period; and
determine a half-cycle event stop condition in response to the value of the in-motion signal crossing below one-half of the total of the in-motion maximum value and the in-motion minimum value for the specified transition time period.

19. The computer program product of claim 18, wherein the specified safe amount of time is two seconds, and the specified transition time period is four seconds.
